(19) United States
(12) Patent Application Publication
(10) Pub. No.: US 2025/0152983 A1
(43) Pub. Date: May 15, 2025

(54) ACTIVATION SYSTEM FOR DISPENSER COMPONENTS FOR FIRE-FIGHTING SYSTEMS

(71) Applicant: FIRTECH SRL, Taranto (IT)

(72) Inventor: Cataldo BORRACCINO, Taranto (IT)

(21) Appl. No.: 18/530,951

(22) Filed: Dec. 6, 2023

(30) Foreign Application Priority Data
Nov. 10, 2023 (EP) 23209178.5

(51) Int. Cl. A62C 37/12; A62C 31/00

(52) U.S. Cl. CPC A62C 37/12; A62C 31/005

(57) ABSTRACT

An activation system for dispenser components for fire-fighting systems, which comprises a plurality of fluid chambers that are hermetically isolated from each other, each of the fluid chambers being configured to break at a preset temperature;
wherein the activation system is configured to be automatically actuated, based on the breakage of any of the fluid chambers.

The present invention relates to an activation system for dispenser components for systems for extinguishing fires, in short, fire-fighting systems.

The activation system according to the present invention is particularly, although not exclusively, useful and practical for use in valves and/or nozzles for fire-fighting systems.

As is known, in civilian, industrial and military environments, and the like, automatically-activated fire-fighting systems are normally present which, upon the occurrence of a condition as, for example, the detection of a fire or the exceeding of a preset air temperature threshold, emit an extinguishing fluid in order to extinguish the fire.

Typically, the extinguishing fluid consists essentially of water (in atomized form, or with the addition of fire-fighting products) or of an extinguishing gas. Usually, the dispensing of the extinguishing fluid occurs via dispenser components, for example nozzles and valves, which are activated automatically via an activation system.

In some known dispenser components, the operation of the activation system is based on the presence in the dispenser component of a thermosensitive element, i.e. an element that is configured to detect and make manifest that a preset temperature has been reached, or that a preset temperature threshold has been exceeded. In practice, upon reaching a preset temperature, or upon exceeding a preset temperature threshold, the thermosensitive element present in the dispenser component can change a physical characteristic thereof, for example by breaking, and this change causes an activation of the dispenser component.

Although useful and practical, these known dispenser components are not devoid of drawbacks, such as the fact that they are affected by malfunctions owing to failure of the activation system to intervene. In practice, in the event of a fault, a malfunction or a defect in the thermosensitive element, the activation system remains in an inactive or rest status, thus preventing the dispenser component from dispensing the extinguishing fluid.

The aim of the present invention is to overcome the limitations of the known art described above, by devising an activation system for dispenser components for fire-fighting systems, and a dispenser component for fire-fighting systems, that make it possible to obtain better effects than those that can be obtained with conventional solutions and/or similar effects at lower cost and with higher performance levels.

Within this aim, an object of the present invention is to devise an activation system and a dispenser component that make it possible to increase the safety of a fire-fighting system.

Another object of the present invention is to devise an activation system and a dispenser component that make it possible to increase the reliability of a fire-fighting system.

A further object of the present invention is to devise an activation system and a dispenser component that make it possible to reduce the risk of faults or malfunctions in a fire-fighting system.

Still further, another object of the present invention is to devise an activation system and a dispenser component that make it possible to increase the efficacy of a fire-fighting system.

Another object of the present invention is to provide an activation system and a dispenser component that are easy and practical to realize, and economically competitive when compared to the known art.

This aim and these and other objects which will become better apparent hereinafter are achieved by an activation system for dispenser components for fire-fighting systems, which comprises a plurality of fluid chambers that are hermetically isolated from each other, each of said fluid chambers being configured to break at a preset temperature;

wherein said activation system is configured to be automatically actuated, based on the breakage of any of said fluid chambers.

The aim and objects are also achieved by a dispenser component for fire-fighting systems, which comprises an activation system according to the present invention.

Further characteristics and advantages of the present invention will become more apparent from the description of some preferred, but not exclusive, embodiments of the activation system and of the dispenser component according to the invention, which are illustrated by way of non-limiting example with the aid of the accompanying drawings wherein:

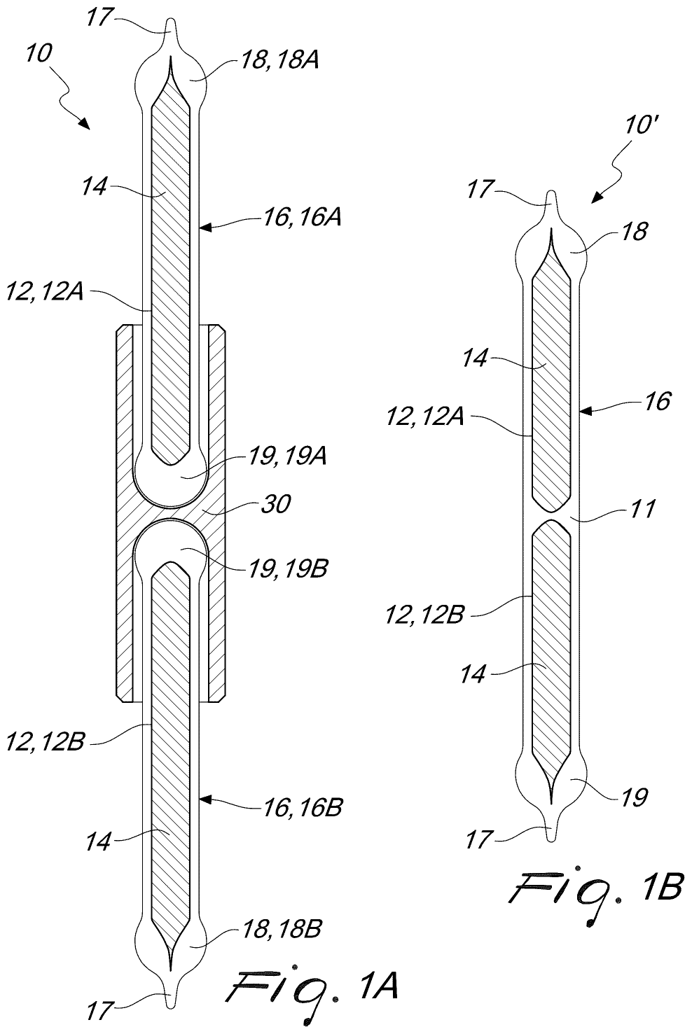

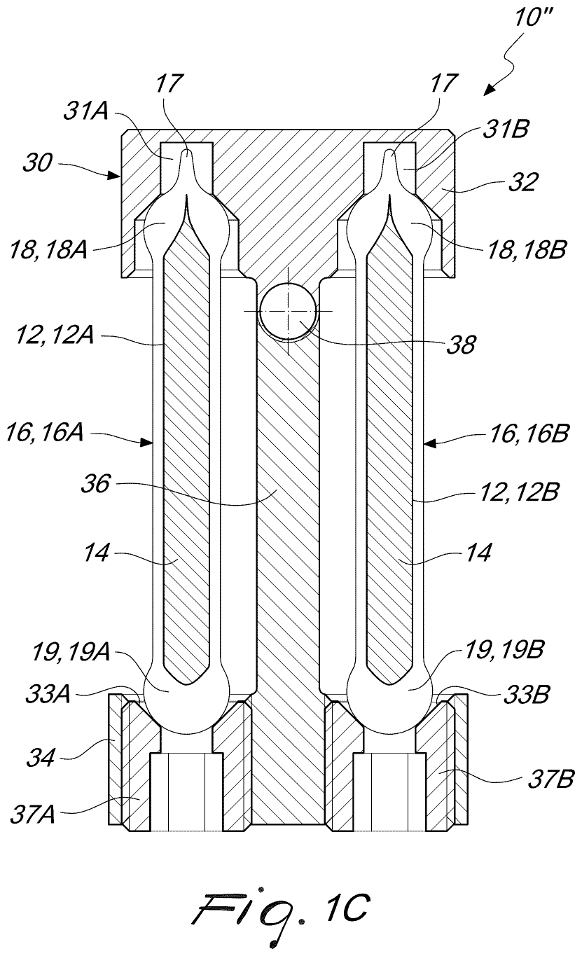

FIGS. 1A, 1B and 1C are longitudinal cross-sectional views of three respective embodiments of the activation system for dispenser components for fire-fighting systems according to the present invention; and

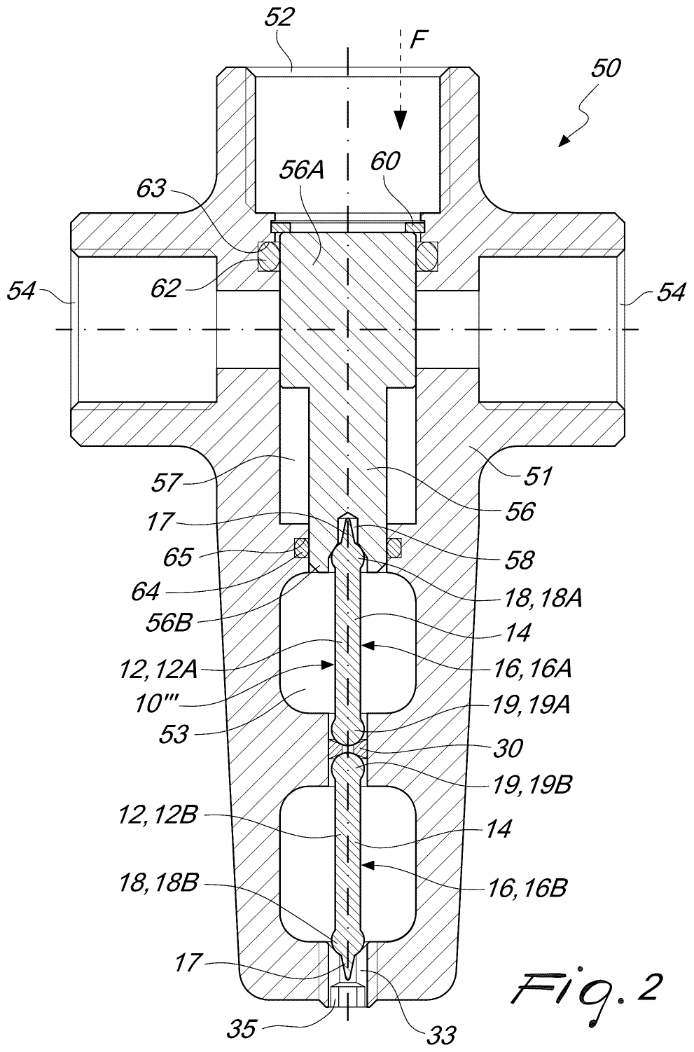

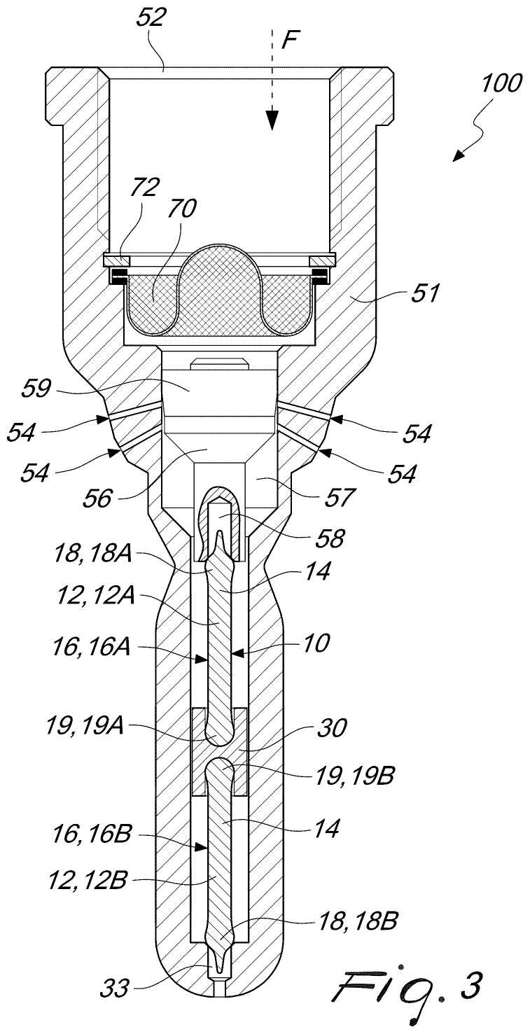

FIGS. 2 and 3 are longitudinal cross-sectional views of two respective embodiments of the dispenser component for fire-fighting systems according to the present invention, wherein each dispenser component comprises an activation system according to the invention.

With reference to the figures, each activation system according to the present invention, generally designated by the reference numerals 10, 10′, 10″ and 10″, comprises a plurality of fluid chambers 12 which are hermetically isolated from each other.

In other words, each fluid chamber 12 includes a closed space inside it, which is hermetically isolated from the outside of that fluid chamber 12 and, as a consequence, hermetically isolated from the other fluid chambers 12.

Furthermore, each fluid chamber 12 is configured to break upon reaching a preset temperature, or upon exceeding a preset temperature threshold.

In particular, the breakage of each fluid chamber 12 can occur by explosion, owing to an expansion of an activator fluid 14 contained in the same fluid chamber 12. The activator fluid 14 can be in the gaseous state or, preferably, in the liquid state.

In practice, when the ambient temperature increases, for example owing to a fire, the activator fluid 14 is heated. As a consequence of this heating, the activator fluid 14 expands and, in so doing, exerts a growing pressure on the internal walls of the fluid chamber 12 that contains that activator fluid 14. Upon reaching the preset temperature, or upon exceeding the preset temperature threshold, this pressure results in an explosion, or in any case a breakage, of that fluid chamber 12.

Each fluid chamber 12 is formed within a thermosensitive element 16. Breakage of the fluid chamber 12 implies the breakage of the thermosensitive element 16.

The preset temperature, or the preset temperature threshold, is defined at the design stage of the activation system 10, 10′, 10″, 10″ according to the invention, depending on the specific use of the activation system 10, 10′, 10″, 10″. For example, when the activation system 10, 10′, 10″, 10′ is to be inserted in a dispenser component 50, 100 as those described below, the preset temperature is a design variable that depends on the environmental conditions in which it is envisaged that the dispenser component 50, 100 is to operate.

In some preferred embodiments, such as for example those shown in the cited figures, all the fluid chambers 12 that make up the plurality of fluid chambers 12 are identical. In particular, each chamber 12 contains the same activator fluid 14.

However, it is also possible to have other embodiments that are particularly advantageous in terms of reliability, in which at least two of the fluid chambers 12 that make up the plurality of fluid chambers 12 differ in at least one feature. For example, separate fluid chambers 12 can contain different activator fluids 14. Again, for example, fluid chambers 12 can differ in at least one geometric feature, or they can be made by different manufacturers. A diversification between the various fluid chambers 12 that make up the plurality of fluid chambers 12 makes it possible to further reduce the risk of faults or malfunctions of the activation system 10′, 10″, 10′″ according to the invention.

In some preferred embodiments, such as those shown in the cited figures, the plurality of fluid chambers 12 comprises a pair of fluid chambers 12, i.e. a first fluid chamber 12A and a second fluid chamber 12B.

In other embodiments, the plurality of fluid chambers 12 can comprise a number of fluid chambers 12 greater than two (for example three, four, five etc.).

Regardless of the number of fluid chambers 12 that make up the plurality of fluid chambers 12, each activation system 10, 10′, 10″, 10′ is configured to be automatically actuated, based on a breakage of any fluid chamber 12 of the plurality of fluid chambers 12, i.e. when any fluid chamber 12 of the plurality of fluid chambers 12 breaks. Actuation of the activation system 10, 10′, 10″, 10′ implies the activation of the dispenser component 50, 100 in which the same system 10, 10′, 10″, 10′ is installed.

In this manner, an activation system 10, 10′, 10″, 10′″ is obtained which offers high reliability, as it can be activated even if one of the fluid chambers 12 is faulty or malfunctioning. In fact, a fault or a malfunction in one of the fluid chambers 12 can be compensated by the breakage of another fluid chamber 12, thus ensuring an actuation of the activation system 10, 10′, 10″, 10′″ upon reaching the preset temperature, or upon exceeding the preset temperature threshold. This aspect is particularly useful when the activation system 10, 10′, 10″, 10′″ is inserted into a dispenser component 50, 100 like those described below.

In some variants, the first fluid chamber 12A and the second fluid chamber 12B are arranged in series, for example as shown in FIGS. 1A, 1B, 2 and 3.

In particular, the first fluid chamber 12A and the second fluid chamber 12B can be arranged in a row, one behind the next, for example as shown in FIGS. 1A and 1B.

In other variants, the first fluid chamber 12A and the second fluid chamber 12B are arranged in parallel, for example as shown in FIG. 1C.

In particular, the first fluid chamber 12A and the second fluid chamber 12B can be arranged mutually side by side, i.e. beside each other, for example as shown in FIG. 1C.

As mentioned, each fluid chamber 12 is formed within a thermosensitive element 16, and the breakage of the fluid chamber 12 implies the breakage of the thermosensitive element 16.

In some preferred embodiments, the first fluid chamber 12A is formed within a first thermosensitive element 16A, while the second fluid chamber 12B is formed within a second thermosensitive element 16B.

In other words, the first fluid chamber 12A and the second fluid chamber 12B can belong to separate thermosensitive elements 16, such as for example shown in FIGS. 1A, 1C, 2 and 3.

In other preferred embodiments, the first fluid chamber 12A and the second fluid chamber 12B can constitute distinct parts of a single thermosensitive element 16, such as for example shown in FIG. 1B.

In particular, in FIG. 1B, the thermosensitive element 16 comprises a septum portion 11 that separates the first fluid chamber 12A from the second fluid chamber 12B, and vice versa.

Preferably, each thermosensitive element 16, 16A, 16B is made of glass or of a material that melts under heat.

In the preferred and illustrated embodiments, each thermosensitive element 16, 16A, 16B is bulb-shaped. In particular, each thermosensitive element 16, 16A, 16B is cylindrical, ending in two bulb-shaped ends 18, 19. In other words, each end 18, 19 of the thermosensitive element 16, 16A, 16B is bulb-shaped.

In some variants, at least one of the bulb-shaped ends 18, 19 of each thermosensitive element 16, 16A, 16B comprises a pointed tip 17.

For example, in FIGS. 1A, 1C, 2 and 3, only one of the bulb-shaped ends 18, 19 of each thermosensitive element 16A, 16B is provided with a pointed tip 17, i.e. the bulb-shaped end 18A for the thermosensitive element 16A and the bulb-shaped end 18B for the thermosensitive element 16B.

By contrast, in FIG. 1B, both bulb-shaped ends 18, 19 of the thermosensitive element 16 are provided with a respective pointed tip 17. In other words, in FIG. 1B, the thermosensitive element 16 is double-tipped.

However, alternative variants and embodiments (not shown) are also possible, in which each bulb-shaped end 18, 19 of the thermosensitive element 16 has no pointed tips. For example, in these alternative variants, at least one of the bulb-shaped ends 18, 19 can end with a rounded or flat surface.

In some preferred embodiments, the activation system 10, 10″, 10″ can further comprise a coupling element 30. In these embodiments, the first thermosensitive element 16A is mechanically coupled to the second thermosensitive element 16B via the coupling element 30.

In particular, the coupling element 30 can hold the thermosensitive elements 16A and 16B together, rendering them mutually integral as if they were a single thermosensitive element 16.

For example, in the embodiments shown in FIGS. 1A, 2 and 3, the coupling element 30 couples a lower end 19A of the first thermosensitive element 16A to an upper end 19B of the second thermosensitive element 16B.

By contrast, in the embodiment shown in FIG. 1C, the coupling element 30 comprises a first guiding portion 32, a second guiding portion 34 and a columnar portion 36. The first guiding portion 32 defines a first pair of seats 31A-B for a respective first pair of ends 18A-B of the thermosensitive elements 16A-B. The second guiding portion 34 defines a second pair of seats 33A-B for a respective second pair of ends 19A-B of the thermosensitive elements 16A-B. The columnar portion 36 extends between the first guiding portion 32 and the second guiding portion 34.

Preferably, at least one of the pairs of seats 31A-B and 33A-B comprises a threaded seat. For example, in FIG. 1C, each seat 33A, 33B is threaded, and each threaded seat 33A, 33B accommodates a respective grub screw 37A, 37B. In other words, a first grub screw 37A is screwed into a first threaded seat 33A, and a second grub screw 37B is screwed into a second threaded seat 33B. As a consequence, in FIG. 1C, each grub screw 37A, 37B is screwed into the second guiding portion 34.

However, other embodiments (not shown) are also possible, in which at least one of the first grub screw 37A and the second grub screw 37B is screwed into a respective threaded seat of the first guiding portion 32. For example, one or more of the seats 31A-B can be threaded, while one or more of the seats 33A-B can be without thread.

Preferably, each grub screw 37A, 37B is screwed into the respective threaded seat 33A, 33B until it comes into abutment with a respective end 19A, 19B of the thermosensitive elements 16A, 16B. For example, in FIG. 1C, the lower end 19A of the first thermosensitive element 16A is in mechanical contact with an upper portion of the first grub screw 37A, while a lower end 19B of the second thermosensitive element 16B is in mechanical contact with an upper portion of the second grub screw 37B. In this manner, each grub screw 37A, 37B prevents any axial movement of the respective thermosensitive element 16A, 16B.

Furthermore, in some preferred embodiments, the coupling element 30 can comprise at least one movable part.

For example, in the embodiment shown in FIG. 1C, the coupling element 30 comprises a joint 38 that is interposed between the first guiding portion 32 and the columnar portion 36.

In this manner, when one of the fluid chambers 16A, 16B of the activation system 10″ breaks, the first guiding portion 32 can rotate about the joint 38, in the direction of the space generated by this breakage, thereby moving one of the seats 31A-B away from the respective end 18A-B of the thermosensitive element 16A-B that contains the still-intact fluid chamber 12A-B.

In practice, in FIG. 1C, the first guiding portion 32 can be configured to operate like a lever member that has its fulcrum in the joint 38.

The presence of at least one movable part like the one described above is particularly useful and practical for implementing an activation system 10, 10′, 10″, 10′″ for a dispenser component like those described below.

In addition or as an alternative, the first fluid chamber 12A and the second fluid chamber 12B can form a pair of fluid chambers 12 which are configured so that a breakage of either the first fluid chamber 12A or the second fluid chamber 12B causes a breakage of the remaining fluid chamber 12A, 12B of the pair of fluid chambers 12.

In FIGS. 1A and 3, the coupling element 30 is shaped like a two-way straight joint.

By contrast, in FIG. 2, the coupling element 30 is in the form of a bearing.

Preferably, the coupling element 30 is provided with outer lateral surfaces made of a material with a low friction coefficient, for example polytetrafluoroethylene (PTFE).

In some embodiments, the activation system 10, 10′, 10″, 10′ described above constitutes a self-contained unit. In other embodiments, the activation system 10, 10′, 10″, 10′ is comprised in a dispenser component 50, 100, such as for example a valve, a nozzle or a nozzle provided with a valve.

For example, in FIG. 2, the dispenser component is in the form of a valve 50, which comprises the activation system 10″. Instead, in FIG. 3, the dispenser component is in the form of a nozzle 100, which comprises the activation system 10.

In practice, the activation system 10, 10′, 10″, 10′″ can be installed in any dispenser component 50, 100 that comprises:
at least one inlet 52, configured to be fed with an extinguishing fluid F; and
at least one outlet 54, configured to dispense the extinguishing fluid F outside the dispenser component 50, 100.

Advantageously, in some preferred embodiments, the dispenser component 50, 100 further comprises a movable member 56, which is mechanically coupled to at least one thermosensitive element 16, and consequently to the plurality of fluid chambers 12.

In the preferred and illustrated embodiments, the movable member 56 is shaped as a piston configured to move axially along a cylindrical chamber 57 formed in a main body 51 of the dispenser component 50, 100.

In the embodiment shown in FIG. 2, the dispenser component 50 further comprises a retention element 60, in particular a stop ring, configured to prevent an extraction of the movable member 56 from the inlet 52 of the dispenser component 50.

In some preferred embodiments, the movable member 56 includes a receptacle 58, adapted to engage an end 18 of a respective thermosensitive element 16.

For example, in FIGS. 2 and 3, the end 18A of the first thermosensitive element 16A engages the receptacle 58 of the movable member 56.

Still with reference to FIGS. 2 and 3, the end 18B of the second thermosensitive element 16B engages a respective receptacle 33, and is provided in a bottom portion of the main body 51.

Optionally, the receptacle 33 can be realized as a through hole (preferably threaded) that is either blocked, or capable of being blocked, from the outside of the main body 51 via a plug 35 (also preferably threaded).

In practice, the function of the receptacles 33 and 58 comprised in the dispenser components 50, 100 shown in FIGS. 2 and 3 is similar to the function of the pairs of seats 31A-B and 33A-B comprised in the activation system 10″ shown in FIG. 1C.

The movable member 56 of the dispenser component 50, 100, if any, is configured to automatically move from a closed position to an open position, when any fluid chamber 12 of the plurality of fluid chambers 12 breaks.

In the closed position, the movable member 56 of the dispenser component 50, 100 prevents a passage of the extinguishing fluid F from the inlet 52 to the at least one outlet 54, for example as shown in FIGS. 2 and 3. In other words, in the closed position, the movable member 56 isolates each outlet 54 from the inlet 52.

By contrast, in the open position, the movable member 56 of the dispenser component 50, 100 puts the inlet 52 in fluid communication with the at least one outlet 54.

In practice, upon reaching the preset temperature, i.e. the temperature at which one or more of the fluid chambers 12 that form the plurality of fluid chambers 12 is configured to break, the breakage of any of the fluid chambers 12, and therefore of the respective thermosensitive element 16, causes a displacement of the movable member 56, which moves from the closed position to the open position.

As a consequence, when the inlet 52 is supplied with the extinguishing fluid F, the displacement of the movable member 56 allows the extinguishing fluid F to pass from the inlet 52 to the at least one outlet 54, through which the extinguishing fluid F is dispensed outside of the dispenser component 50, 100.

Advantageously, the isolation between the inlet 52 and the at least one outlet 54 can be facilitated by the presence of one or more sealing elements.

For example, in the embodiment shown in FIG. 2, the dispenser component 50 comprises an O-ring 62, accommodated in a dedicated seat 63 provided in the main body 51, and the O-ring 62 is interposed between a head portion 56A of the movable member 56 and the corresponding seat 63.

Again, for example, in the embodiment shown in FIG. 3, the dispenser component 100 comprises a gasket 59, placed to cap the movable member 56, and the gasket 59 is dimensioned so as to interfere mechanically with the side walls of the cylindrical chamber 57. Preferably, the gasket 59 is made of rubber or of another elastomeric material.

In practice, in FIGS. 2 and 3, the O-ring 62 and the gasket 59, respectively, constitute a sealing element configured to hermetically isolate the cylindrical chamber 57, and consequently each outlet 54, from the inlet 52 when the movable member 56 is in the closed position.

Further sealing elements or gaskets can be used to prevent a communication of fluid between other internal regions of the dispenser component 50, 100, in particular of the corresponding main body 51.

For example, in the embodiment shown in FIG. 2, the dispenser component 50 comprises an additional O-ring 64, accommodated in a dedicated seat 65 provided in the main body 51, and the O-ring 64 is interposed between a bottom portion 56B of the movable member 56 and the corresponding seat 65. In this manner, the O-ring 64 hermetically isolates the cylindrical chamber 57, and consequently each outlet 54, from an inner region 53 of the main body 51 which includes the first thermosensitive element 16A.

Advantageously, the dispenser component 50, 100 can include a filtering element 70, arranged upstream of the movable member 56 and downstream of the inlet 52. In particular, in the embodiment shown in FIG. 3, the filtering element 70 is a wave filter.

The presence of a filtering element 70 in the dispenser component 50, 100 is particularly useful and practical for minimizing the risk that impurities present in the extinguishing fluid F could obstruct one or more outlets 54. This aspect is particularly important for outlets 54 shaped like dispensing holes, such as for example in the nozzle 100 shown in FIG. 3.

Preferably, the filtering element 70 can be fixed to the main body 51 of the dispenser component 50, 100 via a stop ring 72.

In practice it has been found that the present invention fully achieves the set aim and objects. In particular, it has been seen that the activation system for dispenser components for fire-fighting systems, and the dispenser component for fire-fighting systems, thus conceived make it possible to overcome the qualitative limitations of the known art, in that they make it possible to obtain better effects than those that can be obtained with conventional solutions and/or similar effects at lower cost and with higher performance levels.

An advantage of the activation system and of the dispenser component according to the present invention consists in that they make it possible to improve the safety of a fire-fighting system.

Another advantage of the activation system and of the dispenser component according to the present invention consists in that they make it possible to increase the reliability of a fire-fighting system.

A further advantage of the activation system and of the dispenser component according to the present invention consists in that they make it possible to reduce the risk of faults or malfunctions in a fire-fighting system.

Still further, another advantage of the activation system and of the dispenser component according to the present invention consists in that they make it possible to increase the efficacy of a fire-fighting system.

In practice, the above advantages derive from the fact that, thanks to the activation system according to the invention, the dispenser component for fire-fighting systems can be activated even in the event of faults or malfunctions of a thermosensitive element or of a fluid chamber contained in it, by virtue of the presence of at least one other fluid chamber which can break in place of the faulty or malfunctioning chamber.

Although the activation system according to the invention has been conceived in particular for valves and/or nozzles for fire-fighting systems, such as for example those shown in FIGS. 2 and 3, respectively, it can also be used, more generally, for any type of heat-activated dispenser component for fire-fighting systems.

In the description of the preferred and illustrated embodiments, elements that are identical in structure or function and/or elements that belong to a same structure or to a same functional group are designated by reference numbers with the same numeral component.

Furthermore, in the present description, expressions like “first”, “second” and the like may be used to distinguish one element from another in a non-limiting manner, irrespective of any order or hierarchy among the various elements. In practice, in some embodiments, a “first thermosensitive element” could constitute a “second thermosensitive element” and, conversely, a “second thermosensitive element” could constitute a “first thermosensitive element”.

The invention thus conceived is susceptible of numerous modifications and variations, all of which are within the scope of the appended claims; via non-limiting example, the person skilled in the art will understand without effort that embodiments are possible that comprise a plurality of different thermosensitive elements (for example, a pair of thermosensitive elements formed by the combination of a first thermosensitive element with a double chamber and a second thermosensitive element with a single chamber).

Except where indicated otherwise, the various embodiments described above can be combined in order to provide further and/or alternative embodiments. In addition, the present description covers combinations of variations and preferred embodiments that are not explicitly described.

Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the figures or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in European Patent Application No. 23209178.5 from which this application claims priority are incorporated herein by reference.

What is claimed is:

1. An activation system for dispenser components for fire-fighting systems, which comprises a plurality of fluid chambers that are hermetically isolated from each other, each of said fluid chambers being configured to break at a preset temperature;
wherein said activation system is configured to be automatically actuated, based on the breakage of any of said fluid chambers.

2. The activation system according to claim 1, wherein said plurality of fluid chambers comprises a first fluid chamber and a second fluid chamber.

3. The activation system according to claim 2, wherein said first fluid chamber and said second fluid chamber are arranged in series.

4. The activation system according to claim 3, wherein said first fluid chamber and said second fluid chamber are distinct parts of a single thermosensitive element.

5. The activation system according to claim 2, wherein said first fluid chamber and said second fluid chamber are arranged in parallel.

6. The activation system according to claim 2, wherein said first fluid chamber is formed within a first thermosensitive element, and wherein said second fluid chamber is formed within a second thermosensitive element.

7. The activation system according to claim 6, which further comprises a coupling element, said first thermosensitive element being mechanically coupled to said second thermosensitive element via said coupling element.

8. The activation system according to claim 5, wherein said first and second fluid chamber form a pair of fluid chambers which are configured so that a breakage of either said first or second fluid chamber causes a breakage of the remaining fluid chamber of said pair of fluid chambers.

9. A dispenser component for fire-fighting systems, which comprises an activation system according to claim 1.

10. The dispenser component according to claim 9, further comprising:
an inlet, configured to be fed with an extinguishing fluid;
at least one outlet, configured to dispense said extinguishing fluid outside said dispenser component; and
a movable member, mechanically coupled to a plurality of fluid chambers of said activation system, said movable member being configured to:
move from a closed position, in which said movable member prevents a passage of said extinguishing fluid from said inlet to said at least one outlet, to an open position, in which said movable member puts said at least one outlet in fluid communication with said inlet; and
automatically move from said closed position to said open position, when any fluid chamber of said plurality of fluid chambers breaks.
